(19) United States
(12) Patent Application Publication
(10) Pub. No.: US 2023/0332013 A1
(43) Pub. Date: Oct. 19, 2023

(54) ISOCYANATE-FUNCTIONAL PREPOLYMER, COMPOSITION COMPRISING SAME, AND COATING FORMED THEREWITH

(71) Applicants: DOW SILICONES CORPORATION, Midland, MI (US); DOW GLOBAL TECHNOLOGIES LLC, Midland, MI (US)

(72) Inventors: Adam L. GRZESIAK, Midland, MI (US); Mark P. ALLEN, Auburn Hills, MI (US); Amy L. REDER, Midland, MI (US); David A. SHAWL, Midland, MI (US); Todd M. STARKE, Midland, MI (US)

(21) Appl. No.: 18/025,435

(22) PCT Filed: Sep. 10, 2021
(86) PCT No.: PCT/US2021/049848

§ 371 Date: Mar. 9, 2023

Related U.S. Application Data
(60) Provisional application No. 63/077,185, filed on Sep. 11, 2020.

(51) Int. Cl. C09D 175/08; C08G 18/12; C08G 18/48; C08G 18/61; C08G 18/40; C08G 18/76; C08K 7/26; C09D 7/61; D06N 3/00; D06N 3/14; B60R 21/235; B60R 21/231

(52) U.S. Cl. CPC C09D 175/08; C08G 18/12; C08G 18/4825; C08G 18/4829; C08G 18/61; C08G 18/4009; C08G 18/7671; C08K 7/26; C09D 7/61; D06N 3/0006; D06N 3/0011; D06N 3/147; B60R 21/235; B60R 21/231; D06N 2201/02; D06N 2203/068; B60R 2021/23514; B60R 2021/23542

(57) ABSTRACT

An isocyanate-functional prepolymer comprises the reaction product of: (A) a polyol; (B) an organopolysiloxane having at least two carbinol-functional groups per molecule; and (C) a polyisocyanate. Components (A) to (C) are utilized to provide a stoichiometric excess of isocyanate-functional groups in component (C) over the total amount of isocyanate-reactive groups of components (A) and (B). An isocyanate component comprising the isocyanate-functional prepolymer is also disclosed. The isocyanate component also comprises (E) a filler. In addition, a composition is disclosed, which comprises the isocyanate component and an isocyanate-reactive component. Further, a method of preparing a coating with the composition is disclosed, which method comprises applying the composition on a substrate and forming the coating from the composition on the substrate. A coated substrate comprising the substrate and a coating disposed on the substrate, the coating being formed from the composition, is additionally disclosed.

### CROSS REFERENCE TO RELATED APPLICATIONS

This application claims priority to and all advantages of U.S. Provisional Patent Application No. 63/077,185 filed on 11 Sep. 2020, the content of which is incorporated herein by reference.

### TECHNICAL FIELD

The subject disclosure generally relates to a prepolymer and, more specifically, to an isocyanate-functional prepolymer, a composition comprising the same, and a coating formed therewith.

### BACKGROUND

Coatings are known in the art and utilized in myriad industries. For example, coatings are utilized in the automotive industry, e.g. in connection with air bags. Such coatings can be utilized both to reduce friction when deploying an air bag and to retain gasses released into the air bag when deployed. Conventional coatings for air bags are typically based on polyurethanes or silicones. Silicones provide excellent performance, but are particularly expensive and require significant coating levels, which influence vehicle light-weighting efforts. Polyurethanes are generally utilized in the form of a dispersion, which requires additional processing associated with devolatization. Reduction of water content to avoid such processing steps with dispersions results in other deleterious impact, such as the requirement for increased pumping pressures due to rheology.

### BRIEF SUMMARY

An isocyanate-functional prepolymer is disclosed, which comprises the reaction product of: (A) a polyol; (B) an organopolysiloxane having at least two carbinol-functional groups per molecule; and (C) a polyisocyanate. Components (A) to (C) are utilized to provide a stoichiometric excess of isocyanate-functional groups in component (C) over the total amount of isocyanate-reactive groups of components (A) and (B).

An isocyanate component comprising the isocyanate-functional prepolymer is also disclosed. The isocyanate component also comprises (E) a filler.

In addition, a composition is disclosed, which comprises the isocyanate component and an isocyanate-reactive component. Further, a method of preparing a coating with the composition is disclosed, which method comprises applying the composition on a substrate and forming the coating from the composition on the substrate. A coated substrate comprising the substrate and a coating disposed on the substrate, the coating being formed from the composition, is additionally disclosed.

### DETAILED DESCRIPTION OF THE INVENTION

An isocyanate-functional prepolymer is disclosed. The isocyanate-functional prepolymer can be utilized in compositions to form a polyurethane, which is typically in the form of an elastomer rather than a foam. The polyurethane has excellent properties for use in automotive applications, particularly as a coating (e.g. for an air bag), as described below. However, end use applications of the polyurethane and/or the coating are not so limited.

The isocyanate-functional prepolymer comprises the reaction product of: (A) a polyol; (B) an organopolysiloxane having at least two carbinol-functional groups per molecule; and (C) a polyisocyanate. Components (A)-(C) are utilized to provide a stoichiometric excess of isocyanate-functional groups in component (C) over the total amount of isocyanate-reactive groups of components (A) and (B). Typically, the isocyanate-functional prepolymer itself can be referred to as a polyisocyanate, i.e., the isocyanate-functional prepolymer typically includes two or more isocyanate functional groups. In these or other embodiments, the isocyanate-functional prepolymer is free from isocyanate-reactive groups, e.g. those present in components (A) and (B), which are consumed in preparing the isocyanate-functional prepolymer.

In certain embodiments, the (A) polyol comprises, alternatively consists of, a polyether polyol. Polyether polyols suitable for preparing the isocyanate-functional prepolymer include, but are not limited to, products obtained by the polymerization of a cyclic oxide, for example, ethylene oxide (“EO”), propylene oxide (“PO”), butylene oxide (“BO”), tetrahydrofuran, or epichlorohydrin, in the presence of polyfunctional initiators. Suitable initiators contain more than one, i.e., a plurality of, active hydrogen atoms. Catalysis for this polymerization can be either anionic or cationic, with suitable catalysts including KOH, CsOH, boron trifluoride, or a double metal cyanide complex (DMC) catalyst such as zinc hexacyanocobaltate or a quaternary phosphazenium compound. The initiator may be selected from, for example, neopentylglycol; 1,2-propylene glycol; water; trimethylolpropane; pentaerythritol; sorbitol; sucrose; glycerol; aminoalcohols, such as ethanolamine, diethanolamine, and triethanolamine; alkanediols, such as 1,6-hexanediol, 1,4-butanediol, 1,3-butane diol, 2,3-butanediol, 1,3-propanediol, 1,2-propanediol, 1,5-pentanediol, 2-methylpropane-1,3-diol, 1,4-cyclohexane diol, 1,3-cyclohexanedimethanol, 1,4-cyclohexanedimethanol, and/or 2,5-hexanediol; ethylene glycol; diethylene glycol; triethylene glycol; bis-3-aminopropyl methylamine; ethylene diamine; diethylene triamine; 9(1)-hydroxymethyloctadecanol; 1,4-bishydroxymethylcyclohexane; hydrogenated bisphenol; 9,9(10,10)-bishydroxymethyloctadecanol; 1,2,6-hexanetriol; and combinations thereof. Other initiators include other linear and cyclic compounds containing an amine group. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine; various isomers of toluene diamine; diphenylmethane diamine; N-methyl-1,2-ethanediamine, N-methyl-1,3-propanediamine; N,N-dimethyl-1,3-diaminopropane; N,N-dimethylethanolamine; 3,3′-diamino-N-methyldipropylamine; N,N-dimethyldipropylenetriamine; aminopropyl-imidazole; and combinations thereof. As understood in the art, the initiator compound, or combination thereof, is generally selected based on desired functionality of the resulting polyether polyol.

Other suitable polyether polyols include polyether diols and triols, such as polyoxypropylene diols and triols and poly(oxyethylene-oxypropylene)diols and triols obtained by the simultaneous or sequential addition of ethylene and propylene oxides to di- or tri-functional initiators. Polyether polyols having higher functionalities than triols can also be utilize in lieu of or in addition to polyether diols and/or triols. Copolymers having an oxyethylene content of from 5 to 90% by weight, based on the weight of the copolymer, can be utilized. When the (A) polyol is a copolymer, the copolymer can be a block copolymer, a random/block copolymer or a random copolymer. The (A) polyol can also be a terpolymer. Yet other suitable polyether polyols include polytetramethylene glycols obtained by the polymerization of tetrahydrofuran.

In other embodiments, the (A) polyol comprises, alternatively consists of, a polyester polyol. Polyester polyols suitable for preparing the isocyanate-functional prepolymer include, but are not limited to, hydroxyl-functional reaction products of polyhydric alcohols (including mixtures thereof), such as ethylene glycol, propylene glycol, diethylene glycol, 1,4-butanediol, neopentylglycol, 1,6-hexanediol, cyclohexane dimethanol, glycerol, trimethylolpropane, pentaerythritol, sucrose, polyether polyols; and polycarboxylic acids, particularly dicarboxylic acids or their ester-forming derivatives, for example succinic, glutaric and adipic acids or their dimethyl esters, sebacic acid, phthalic anhydride, tetrachlorophthalic anhydride, dimethyl terephthalate or mixtures thereof. Polyester polyols obtained by the polymerization of lactones, e.g. caprolactone, in conjunction with a polyol, or of hydroxy carboxylic acids, e.g. hydroxy caproic acid, may also be used. In certain embodiments, the (A) polyol comprises a mixture of polyester and polyether polyols.

Suitable polyesteramide polyols may be obtained by the inclusion of aminoalcohols such as ethanolamine in polyesterification mixtures. Suitable polythioether polyols include products obtained by condensing thiodiglycol either alone or with other glycols, alkylene oxides, dicarboxylic acids, formaldehyde, aminoalcohols or aminocarboxylic acids. Suitable polycarbonate polyols include products obtained by reacting diols such as 1,3-propanediol, 1,4-butanediol, 1,6-hexanediol, diethylene glycol or tetraethylene glycol with diaryl carbonates, e.g. diphenyl carbonate, or with phosgene. Suitable polyacetal polyols include those prepared by reacting glycols such as diethylene glycol, triethylene glycol or hexanediol with formaldehyde. Other suitable polyacetal polyols may also be prepared by polymerizing cyclic acetals. Suitable polyolefin polyols include hydroxy-terminated butadiene homo- and copolymers and suitable polysiloxane polyols include polydimethylsiloxane diols and triols.

In certain embodiments, the (A) polyol is a polymer polyol. In specific embodiments, the polymer polyol is a graft polyol. Graft polyols may also be referred to as graft dispersion polyols or graft polymer polyols. Graft polyols often include products, i.e., polymeric particles, obtained by the in-situ polymerization of one or more vinyl monomers, e.g. styrene monomers and/or acrylonitrile monomers, and a macromer in a polyol, e.g. a polyether polyol.

In other embodiments, the polymer polyol is chosen from polyharnstoff (PHD) polyols, polyisocyanate polyaddition (PIPA) polyols, and combinations thereof. PHD polyols are typically formed by in-situ reaction of a diisocyanate with a diamine in a polyol to give a stable dispersion of polyurea particles. PIPA polyols are similar to PHD polyols, except that the dispersion is typically formed by in-situ reaction of a diisocyanate with an alkanolamine instead of a diamine, to give a polyurethane dispersion in a polyol. In yet other embodiments, the polymer polyol comprises a co-polymer polyol based on styrene-acrylonitrile (SAN).

It is to be appreciated that the (A) polyol utilized to form the isocyanate-functional prepolymer may include any combination of two or more polyols that are different from one another based on functionality, molecular weight, viscosity, or structure.

In various embodiments, the (A) polyol has a hydroxyl (OH) number of from greater than 10 to 120, alternatively from 20 to 90, alternatively from 30 to 80, alternatively from 40 to 70, alternatively from 50 to 60, mg KOH/g. Hydroxyl number can be measured via various techniques, such as in accordance with ASTM D4274. In these or other embodiments, the (A) polyol has a number average molecular weight of from 1,000 to 4,000, alternatively from 1,250 to 3,000, alternatively from 1,500 to 2,500, alternatively from 1,750 to 2,250, alternatively from 1,900 to 2,100, Daltons. As readily understood in the art, number average molecular weight can be measured via gel permeation chromatography (GPC).

In these or other embodiments, the (A) polyol has a functionality of from 2 to 10, alternatively from 2 to 9, alternatively from 2 to 8, alternatively from 2 to 7, alternatively from 2 to 6, alternatively from 2 to 5, alternatively from 2 to 4, alternatively from 2 to 3, alternatively 2.

It is to be appreciated that when the (A) polyol comprises a blend of two or more different polyols, the properties above may be based on the overall (A) polyol, i.e., averaging the properties of the individual polyols in the (A) polyol, or may relate to a specific polyol in the blend of polyols. Typically, these properties relate to the overall (A) polyol. In specific embodiments, the (A) polyol comprises, alternatively consists essentially of, alternatively consists of, one or more polyether polyols. Said differently, in these embodiments, the (A) polyol is typically free from any polyols that are not polyether polyols. In these or other embodiments, the (A) polyol comprises, alternatively is, a homopolymer diol.

The isocyanate-functional prepolymer is also the reaction product of (B) an organopolysiloxane having an average of at least two carbinol-functional groups per molecule. The carbinol-functional groups can be the same as or different from one another. Carbinol-functional groups on organopolysiloxanes are distinguished from silanol groups, where carbinol-functional groups include a carbon-bonded hydroxyl group, and silanol functional groups include a silicon-bonded hydroxyl group. Said differently, carbinol-functional groups are of formula —COH, whereas silanol functional groups are of formula —SiOH. These functional groups perform differently; for example, silanol functional groups can readily condense to give siloxane (—Si—O—Si—) bonds, which generally does not occur with carbinol-functional groups (at least under the same catalysis of hydrolysis of silanol functional groups).

In certain embodiments, the carbinol-functional groups independently have the general formula -D-Oₐ—(C_{b}H_{2b}O)_{c}—H, where D is a covalent bond or a divalent hydrocarbon linking group having from 2 to 18 carbon atoms, subscript a is 0 or 1, subscript b is independently selected from 2 to 4 in each moiety indicated by subscript c, and subscript c is from 0 to 500, with the proviso that subscripts a and c are not simultaneously 0.

In one embodiment, subscript c is at least one such that at least one of the carbinol-functional groups has the general formula:

-D-Oₐ—[C₂H₄O]ₓ[C₃H₆O]_{y}[C₄H₈O]_{z}—H;

where D is a covalent bond or a divalent hydrocarbon linking group having from 2 to 18 carbon atoms, subscript a is 0 or 1, 0≤x≤500, 0≤y≤500, and 0≤z≤500, with the proviso that 1≤x+y+z≤500. In these embodiments, the carbinol-functional group may alternatively be referred to as a polyether group or moiety, although the polyether group or moiety terminates with —COH, rather than —COR⁰, where R⁰ is a monovalent hydrocarbon group. As understood in the art, moieties indicated by subscript x are ethylene oxide (EO) units, moieties indicated by subscript y are propylene oxide (PO) units, and moieties indicated by subscript z are butylene oxide (BO) units. The EO, PO, and BO units, if present, may be in block or randomized form in the polyether group or moiety. The relative amounts of EO, PO, and BO units, if present, can be selectively controlled based on desired properties of the (B) organopolysiloxane, composition, and resulting polyurethane article. For example, the molar ratios of such alkylene oxide units can influence hydrophilicity and other properties.

In another embodiment, subscript c is 0 and subscript a is 1 such that at least one of the carbinol-functional groups has the general formula: -D-OH, where D is described above. In these embodiments, the carbinol-functional groups having this general formula are not polyether groups or moieties.

Regardless of the independent selection of the carbinol-functional groups of component (B), component (B) is typically substantially linear. By substantially linear, it is meant that component (B) comprises, consists essentially of, or consists of only M and D siloxy units. As readily understood in the art, M siloxy units are of formula [R³SiO_{1/2}] and D siloxy units are of formula [R²SiO_{2/2}]. Traditionally, M and D siloxy nomenclature is utilized in connection with only methyl substitution. However, for purposes of this disclosure, in the M and D siloxy units above, R is independently selected from substituted or unsubstituted hydrocarbyl groups or carbinol-functional groups, with the proviso that at least two of R are independently selected carbinol-functional groups. When an M siloxy unit includes at least one carbinol-functional group, the carbinol-functional group is terminal. When a D siloxy unit includes at least one carbinol-functional group, the carbinol-functional group is pendent. The substantially linear organopolysiloxane may have the average formula: R^{a′}SiO_{(4-a′)/2}, where each R is independently selected and defined above, including the proviso that at least two of R are independently selected carbinol-functional groups, and where subscript a′ is selected such that 1.9≤a′≤2.2.

In general, hydrocarbyl groups suitable for R may independently be linear, branched, cyclic, or combinations thereof. Cyclic hydrocarbyl groups encompass aryl groups as well as saturated or non-conjugated cyclic groups. Cyclic hydrocarbyl groups may independently be monocyclic or polycyclic. Linear and branched hydrocarbyl groups may independently be saturated or unsaturated. One example of a combination of a linear and cyclic hydrocarbyl group is an aralkyl group. General examples of hydrocarbyl groups include alkyl groups, aryl groups, alkenyl groups, halocarbon groups, and the like, as well as derivatives, modifications, and combinations thereof. Examples of suitable alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, hexadecyl, octadecyl, as well as branched saturated hydrocarbon groups having from 6 to 18 carbon atoms. Examples of suitable non-conjugated cyclic groups include cyclobutyl, cyclohexyl, and cycyloheptyl groups. Examples of suitable aryl groups include phenyl, tolyl, xylyl, naphthyl, benzyl, and dimethyl phenyl. Examples of suitable alkenyl groups include vinyl, allyl, propenyl, isopropenyl, butenyl, isobutenyl, pentenyl, heptenyl, hexenyl, hexadecenyl, octadecenyl and cyclohexenyl groups. Examples of suitable monovalent halogenated hydrocarbon groups (i.e., halocarbon groups, or substituted hydrocarbon groups) include halogenated alkyl groups, aryl groups, and combinations thereof. Examples of halogenated alkyl groups include the alkyl groups described above where one or more hydrogen atoms is replaced with a halogen atom such as F or Cl. Specific examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, and 3,4-difluoro-5-methylcycloheptyl, chloromethyl, chloropropyl, 2-dichlorocyclopropyl, and 2,3-dichlorocyclopentyl groups, as well as derivatives thereof. Examples of halogenated aryl groups include the aryl groups described above where one or more hydrogen atoms is replaced with a halogen atom, such as F or Cl. Specific examples of halogenated aryl groups include chlorobenzyl and fluorobenzyl groups.

In specific embodiments, each R that is not a carbinol-functional group is independently selected from alkyl groups having from 1 to 32, alternatively from 1 to 28, alternatively from 1 to 24, alternatively from 1 to 20, alternatively from 1 to 16, alternatively from 1 to 12, alternatively from 1 to 8, alternatively from 1 to 4, alternatively 1, carbon atoms.

The (B) organopolysiloxane may include at least some branching attributable to the presence of T or Q siloxy units. As understood in the art, T units are of formula [RSiO_{3/2}] and Q siloxy units are of formula [SiO_{4/2}], where R is defined above. However, the (B) organopolysiloxane is typically free from such T and Q siloxy units. By “at least some,” it is meant that the (B) organopolysiloxane may include up to 5, alternatively up to 4, alternatively up to 3, alternatively up to 2, alternatively up to 1, alternatively 0, mol % T and Q siloxy units based on all siloxy units present in the (B) organopolysiloxane. If such branching is present in the (B) organopolysiloxane, it is typically attributable to T siloxy units rather than Q siloxy units. Typically, in view of desired viscosities, the (B) organopolysiloxane is a flowable liquid at room temperature, including in the absence of any solvent or carrier vehicle, rather than a gum or resin. While gums or resins can be liquid at room temperature when solubilized or dispersed in a solvent or carrier fluid, such solvents can be undesirable in certain end use applications, as solvents are typically volatilized or otherwise removed during a curing process.

In embodiments where component (B) is linear, component (B) may have the general formula:

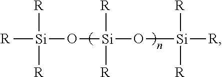

where each R is an independently selected and defined above, including the proviso that at least two of R independently comprise a carbinol-functional group, and subscript n is from 0 to 100. Subscript n may alternatively be referred to as the degree of polymerization (DP) of component (B). Typically, DP is directly proportional to viscosity, all else (e.g. substituents and branching) being equal, i.e., increasing DP increases viscosity. Subscript n is alternatively from greater than 0 to 95, alternatively from greater than 0 to 90, alternatively from greater than 0 to 85, alternatively from greater than 0 to 80, alternatively from greater than 0 to 75, alternatively from greater than 0 to 70, alternatively from greater than 0 to 65. Alternatively, subscript n is from 5 to 70, alternatively from 10 to 65. In one specific embodiment, subscript n is from 5 to 30, alternatively from 10 to 20. In an alternative specific embodiment, subscript n is from 28 to 32, alternatively from 29 to 31, alternatively 30. In an alternative specific embodiment, subscript n is from 48 to 52, alternatively from 49 to 51, alternatively 50. In an alternative specific embodiment, subscript n is from 58 to 62, alternatively from 59 to 61, alternatively 60.

In specific embodiments, each carbinol-functional group has formula -D-OH, and the (B) organopolysiloxane has the following general formula:

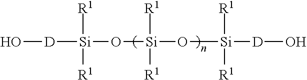

where D and subscript n are defined above, and where each R¹ is an independently selected substituted or unsubstituted hydrocarbyl group, as set forth above for R. In these embodiments, the carbinol-functional groups are terminal in component (B). These carbinol-functional groups may be the same as or different from one another based on D. This formula can alternatively be written as [(OHD-)R¹₂SiO_{1/2}]₂[Si¹₂O_{2/2}]ₙ.

In other embodiments, each carbinol-functional group has the general formula -D-Oₐ—(C_{b}H_{2b}O)_{c}—H, where D and subscripts a-c are defined above, and the carbinol-functional groups are pendent such that the (B) organopolysiloxane has the following general formula:

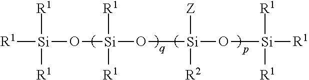

where each R¹ is independently selected and defined above, each subscript Z is -D-Oₐ—(C_{b}H_{2b}O)_{c}—H, where D and subscripts a-c are defined above, each subscript R² is independently selected from R¹ and Z, and subscripts p and q are each from 1 to 99, with the proviso that p+q≤100. In the general formula above, the siloxy units indicated by subscripts q and p may be randomized or in block form. The general formula above is intended to be a representation of the average unit formula of component (B) in this embodiment based on the number of R¹₂SiO_{2/2} units indicated by subscript q and R²ZSiO_{2/2} units indicated by subscript p without requiring a particular order thereof. Thus, this general formula may be written alternatively as [(R¹)₃SiO_{1/2}]₂[(R¹)₂SiO_{2/2}]_{q}[(R¹)ZSiO_{2/2}]ₚ, where subscripts q and p are defined above. In these embodiments, the carbinol-functional groups are polyether groups, and the polyether groups are pendent in component (B). When each R¹ is methyl, this embodiment of component (B) is trimethylsiloxy endblocked, and includes dimethylsiloxy units (indicated by subscript q).

While specific structures of component (B) are exemplified above, component (B) can include terminal polyether groups as the carbinol-functional group, or pendent carbinol-functional groups that are not polyether groups, or any combination of independently selected carbinol-functional groups.

D is typically a function of preparing the (B) organopolysiloxane. For example, the (B) organopolysiloxane may be formed by a hydrosilylation-reaction between an organohydrogenpolysiloxane and an unsaturated carbinol compound. In such embodiments, the organohydrogenpolysiloxane includes silicon-bonded hydrogen atoms at locations (e.g. terminal and/or pendent) where carbinol-functionality is desired. The unsaturated carbinol compound may have formula Y—Oₐ—(C_{b}H_{2b}O)_{c}—H, where Y is an ethylenically unsaturated group, and subscripts a, b, and c are as defined above.

In the hydrosilylation-reaction above, the ethylenically unsaturated group represented by Y can be an alkenyl and/or alkynyl group having from 2 to 18, alternatively from 2 to 16, alternatively from 2 to 14, alternatively from 2 to 12, alternatively from 2 to 8, alternatively from 2 to 4, alternatively 2, carbon atoms. “Alkenyl” means an acyclic, branched or unbranched, monovalent hydrocarbon group having one or more carbon-carbon double bonds. Specific examples thereof include vinyl groups, allyl groups, hexenyl groups, and octenyl groups. “Alkynyl” means an acyclic, branched or unbranched, monovalent hydrocarbon group having one or more carbon-carbon triple bonds. Specific examples thereof include ethynyl, propynyl, and butynyl groups. Various examples of ethylenically unsaturated groups include CH₂═CH—, CH₂═CHCH₂—, CH₂═CH(CH₂)₄—, CH₂=CH(CH₂)₆—, CH₂═C(CH₃)CH₂—, H₂C═C(CH₃)—, H₂C═C(CH₃)—, H₂C═C(CH₃)CH₂—, H₂C═CHCH₂CH₂—, H₂C═CHCH₂CH₂CH₂—, HC≡C—, HC≡CCH₂—, HC≡CCH(CH₃)—, HC≡CC(CH₃)₂—, and HC≡CC(CH₃)₂CH₂—. Typically, ethylenic unsaturation is terminal in Y. As understood in the art, ethylenic unsaturation may be referred to as aliphatic unsaturation. Thus, when D is —CH₂CH₂—, for example, the unsaturated carbinol compound can have formula CH₂=CH—Oₐ—(C_{b}H_{2b}O)_{c}—H, where subscripts a, b, and c are defined above. The number of carbon atoms in D is a function of the number of carbon atoms in the ethylenically unsaturated group, which remains constant even after the hydrosilylation-reaction to prepare component (B).

In certain embodiments, the hydrosilylation-reaction catalyst utilized to form component (B) comprises a Group VIII to Group XI transition metal. Reference to Group VIII to Group XI transition metals is based on the modern IUPAC nomenclature. Group VIII transition metals are iron (Fe), ruthenium (Ru), osmium (Os), and hassium (Hs); Group IX transition metals are cobalt (Co), rhodium (Rh), and iridium (Ir); Group X transition metals are nickel (Ni), palladium (Pd), and platinum (Pt); and Group XI transition metals are copper (Cu), silver (Ag), and gold (Au). Combinations thereof, complexes thereof (e.g. organometallic complexes), and other forms of such metals may be utilized as the hydrosilylation-reaction catalyst.

Additional examples of catalysts suitable for the hydrosilylation-reaction catalyst include rhenium (Re), molybdenum (Mo), Group IV transition metals (i.e., titanium (Ti), zirconium (Zr), and/or hafnium (Hf)), lanthanides, actinides, and Group I and II metal complexes (e.g. those comprising calcium (Ca), potassium (K), strontium (Sr), etc.). Combinations thereof, complexes thereof (e.g. organometallic complexes), and other forms of such metals may be utilized as the hydrosilylation-reaction catalyst.

The hydrosilylation-reaction catalyst may be in any suitable form. For example, the hydrosilylation-reaction catalyst may be a solid, examples of which include platinum-based catalysts, palladium-based catalysts, and similar noble metal-based catalysts, and also nickel-based catalysts. Specific examples thereof include nickel, palladium, platinum, rhodium, cobalt, and similar elements, and also platinum-palladium, nickel-copper-chromium, nickel-copper-zinc, nickel-tungsten, nickel-molybdenum, and similar catalysts comprising combinations of a plurality of metals. Additional examples of solid catalysts include Cu—Cr, Cu—Zn, Cu—Si, Cu—Fe—Al, Cu—Zn—Ti, and similar copper-containing catalysts, and the like.

The hydrosilylation-reaction catalyst may be in or on a solid carrier. Examples of carriers include activated carbons, silicas, silica aluminas, aluminas, zeolites and other inorganic powders/particles (e.g. sodium sulphate), and the like. The hydrosilylation-reaction catalyst may also be disposed in a vehicle, e.g. a solvent which solubilizes the hydrosilylation-reaction catalyst, alternatively a vehicle which merely carries, but does not solubilize, the hydrosilylation-reaction catalyst. Such vehicles are known in the art.

In specific embodiments, the hydrosilylation-reaction catalyst comprises platinum. In these embodiments, the hydrosilylation-reaction catalyst is exemplified by, for example, platinum black, compounds such as chloroplatinic acid, chloroplatinic acid hexahydrate, a reaction product of chloroplatinic acid and a monohydric alcohol, platinum bis(ethylacetoacetate), platinum bis(acetylacetonate), platinum chloride, and complexes of such compounds with olefins or organopolysiloxanes, as well as platinum compounds microencapsulated in a matrix or core-shell type compounds. Microencapsulated hydrosilylation catalysts and methods of their preparation are also known in the art.

Complexes of platinum with organopolysiloxanes suitable for use as the hydrosilylation-reaction catalyst include 1,3-diethenyl-1,1,3,3-tetramethyldisiloxane complexes with platinum. These complexes may be microencapsulated in a resin matrix. Alternatively, the hydrosilylation-reaction catalyst may comprise 1,3-diethenyl-1,1,3,3-tetramethyldisiloxane complex with platinum. The hydrosilylation-reaction catalyst may be prepared by a method comprising reacting chloroplatinic acid with an aliphatically unsaturated organosilicon compound such as divinyltetramethyldisiloxane, or alkene-platinum-silyl complexes. Alkene-platinum-silyl complexes may be prepared, for example by mixing 0.015 mole (COD)PtCl₂ with 0.045 mole COD and 0.0612 moles HMeSiCl₂, where COD is cyclo-octadiene.

The hydrosilylation-reaction catalyst is utilized in the composition in a catalytic amount, i.e., an amount or quantity sufficient to promote curing thereof at desired conditions. The hydrosilylation-reaction catalyst can be a single hydrosilylation-reaction catalyst or a mixture comprising two or more different hydrosilylation-reaction catalysts.

Alternatively, D can be a covalent bond when component (B) is formed via a reaction other than hydrosilylation, e.g. a condensation reaction or a ring opening reaction.

In certain embodiments, component (B) has a capillary viscosity (kinematic viscosity via glass capillary) at 25° C. of from 1 to 1,000, alternatively from 1 to 900, alternatively from 10 to 700, alternatively from 10 to 600, mPa·s. Capillary viscosity can be measured in accordance with Dow Corning Corporate Test Method CTM0004 of 20 Jul. 1970. CTM0004 is known in the art and based on ASTM D445, IP 71. Typically, when component (B) has pendent polyether groups as the carbinol-functional groups, component (B) has a higher viscosity than when component (B) includes terminal carbinol-functional groups that are not polyether groups (as set forth in the exemplary structures above). For example, when component (B) includes pendent polyether groups, the capillary viscosity at 25° C. is typically from 200 to 900, alternatively from 300 to 800, alternatively from 400 to 700, alternatively from 500 to 600 mPa·s. In contrast, when component (B) includes only terminal carbinol-functional groups which are not polyether groups, component (B) may have a capillary viscosity at 25° C. of from greater than 0 to 250, alternatively from greater than 0 to 100, alternatively from greater than 0 to 75, alternatively from 10 to 75, alternatively from 25 to 75, mPa·s.

In these or other embodiments, component (B) may have an OH equivalent weight of from 100 to 2,000, alternatively from 200 to 1,750, alternatively from 300 to 1,500, alternatively from 400 to 1,200 g/mol. Methods of determining OH equivalent weight are known in the art based on functionality and molecular weight.

The isocyanate-functional prepolymer is also the reaction product of (C) a polyisocyanate. As readily understood in the art, the (C) polyisocyanate has two or more isocyanate-functional groups, which react with the OH groups of the (A) polyol and the carbinol-functional groups of the (B) organopolysiloxane when forming the isocyanate-functional prepolymer.

Suitable (C) polyisocyanates have two or more isocyanate functionalities, and include conventional aliphatic, cycloaliphatic, araliphatic and aromatic isocyanates. The (C) polyisocyanate may be selected from the group of diphenylmethane diisocyanates (“MDI”), polymeric diphenylmethane diisocyanates (“pMDI”), toluene diisocyanates (“TDI”), hexamethylene diisocyanates (“HDI”), dicyclohexylmethane diisocyanates (“HMDI”), isophorone diisocyanates (“IPDI”), cyclohexyl diisocyanates (“CHDI”), naphthalene diisocyanate (“NDI”), phenyl diisocyanate (“PDI”), and combinations thereof. In certain embodiments, the C) polyisocyanate comprises, consists essentially of, or is a pMDI. In one embodiment, the (C) polyisocyanate is of the formula OCN—R—NCO, wherein R is a hydrocarbon moiety (e.g. a linear, cyclic and/or aromatic moiety). In this embodiment, the (C) polyisocyanate can include any number of carbon atoms, typically from 4 to 20 carbon atoms.

Specific examples of suitable (C) polyisocyanates include: alkylene diisocyanates with 4 to 12 carbons in the alkylene moiety, such as 1,12-dodecane diisocyanate, 2-ethyl-1,4-tetramethylene diisocyanate, 2-methyl-1,5-pentamethylene diisocyanate, 1,4-tetramethylene diisocyanate and 1,6-hexamethylene diisocyanate; cycloaliphatic diisocyanates, such as 1,3- and 1,4-cyclohexane diisocyanate as well as any mixtures of these isomers, 1-isocyanato-3,3,5-trimethyl-5-isocyanatomethylcyclohexane, 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures; and aromatic diisocyanates and polyisocyanates, such as 2,4- and 2,6-toluene diisocyanate and the corresponding isomeric mixtures, 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates, as well as mixtures of MDI and toluene diisocyanate (TDI).

The (C) polyisocyanate may include modified multivalent isocyanates, i.e., products obtained by the partial chemical reaction of organic diisocyanates and/or polyisocyanates. Examples of suitable modified multivalent isocyanates include diisocyanates and/or polyisocyanates containing ester groups, urea groups, biuret groups, allophanate groups, carbodiimide groups, isocyanurate groups, and/or urethane groups. Specific examples of suitable modified multivalent isocyanates include organic polyisocyanates containing urethane groups and having an NCO content of 15 to 33.6 parts by weight based on the total weight, e.g. with low molecular weight diols, triols, dialkylene glycols, trialkylene glycols, or polyoxyalkylene glycols with a molecular weight of up to 6000; modified 4,4′-diphenylmethane diisocyanate or 2,4- and 2,6-toluene diisocyanate, where examples of di- and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols. Prepolymers containing NCO groups with an NCO content of from 3.5 to 29 parts by weight based on the total weight of the (C) polyisocyanate and produced from the polyester polyols and/or polyether polyols; 4,4′-diphenylmethane diisocyanate, mixtures of 2,4′- and 4,4′-diphenylmethane diisocyanate, 2,4- and/or 2,6-toluene diisocyanates or polymeric MDI are also suitable. Furthermore, liquid polyisocyanates containing carbodiimide groups having an NCO content of from 15 to 33.6 parts by weight based on the total weight of the (2) isocyanate component, may also be suitable, e.g. based on 4,4′- and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate.

It is to be appreciated that the (C) polyisocyanate may include any combination of two or more polyisocyanates that are different from one another based on functionality, molecular weight, viscosity, or structure. In specific embodiments, the (C) polyisocyanate comprises, consists essentially of, or is, a pMDI.

The (C) polyisocyanate typically has a functionality of from 2.0 to 5.0, alternatively from 2.0 to 4.5, alternatively from 2.0 to 4.0, alternatively from 2.0 to 3.5.

In these or other embodiments, the (C) polyisocyanate has a content of NCO by weight of from 15 to 60, alternatively from 15 to 55, alternatively from 20 to 48.5, wt. %. Methods of determining content of NCO by weight are known in the art based on functionality and molecular weight of the particular isocyanate.

Components (A) to (C) are utilized to provide a stoichiometric excess of isocyanate-functional groups in component (C) over the total amount of isocyanate-reactive groups of components (A) and (B). This can alternatively be referred to as reacting with an isocyanate index of greater than 100. The isocyanate-functional prepolymer has a backbone including both organic moieties from components (A) and (C) and one or more siloxane moieties from component (B). Typically, the isocyanate-reactive groups (i.e., OH groups of component (A) and carbinol-functional groups of component (B)) are consumed in preparing the isocyanate-functional prepolymer such that the isocyanate-functional prepolymer does not include any isocyanate-reactive groups. The isocyanate-functional prepolymer includes urethane bonds from the reaction between components (A) and (B) with component (C). The isocyanate-functional prepolymer typically includes an average of at least two isocyanate functional groups.

In certain embodiments, the isocyanate-functional prepolymer has a backbone that comprises one or more siloxane moieties in an amount of from greater than 0 to 20, alternatively from greater than 0 to 17, alternatively from 0.1 to 14, wt. %.

In an alternative embodiment, an isocyanate-functional polymer can be formed by reacting the (A) polyol and (C) polyisocyanate as described above but in the absence of the (B) organopolysiloxane. In this alternative embodiment, the isocyanate-functional polymer does not include any siloxane moieties in its backbone. As readily understood in the art, in this alternative embodiment, the selection of the (A) polyol and (C) polyisocyanate, or their molar ratio, may be influenced and readily optimized due to the lack of the silicon-bonded carbinol-functional groups of component (B), which in the embodiments described above also react with isocyanate-functional groups of the (C) polyisocyanate. The isocyanate-functional polymer of this alternative embodiment is referred to as the isocyanate-functional polymer, as distinguished from the isocyanate-functional prepolymer described above, for clarity.

In certain embodiments, the isocyanate-functional prepolymer and/or the isocyanate-functional polymer is prepared in the presence of a (D) catalyst. That (D) catalyst, if utilized, typically catalyzes the formation of urethane bonds in reacting components (A) and (B) with component (C) in preparing the isocyanate-functional prepolymer.

In one embodiment, the (D) catalyst comprises a tin catalyst. Suitable tin catalysts include tin(II) salts of organic carboxylic acids, e.g. tin(II) acetate, tin(II) octoate, tin(II) ethylhexanoate and tin(II) laurate. In one embodiment, the (D) catalyst comprises dibutyltin dilaurate, which is a dialkyltin(IV) salt of an organic carboxylic acid. Specific examples of suitable organometallic catalyst, e.g. dibutyltin dilaurates, are commercially available from Evonik under the trademark DABCO®. The organometallic catalyst can also comprise other dialkyltin(IV) salts of organic carboxylic acids, such as dibutyltin diacetate, dibutyltin maleate and dioctyltin diacetate.

Examples of other suitable catalysts include iron(II) chloride; zinc chloride; lead octoate; tris(dialkylaminoalkyl)-s-hexahydrotriazines, including tris(N,N-dimethylaminopropyl)-s-hexahydrotriazine; tetraalkylammonium hydroxides, including tetramethylammonium hydroxide; alkali metal hydroxides, including sodium hydroxide and potassium hydroxide; alkali metal alkoxides, including sodium methoxide and potassium isopropoxide; and alkali metal salts of long-chain fatty acids having from 10 to 20 carbon atoms and/or lateral OH groups.

Further examples of other suitable catalysts, specifically trimerization catalysts, include N,N,N-dimethylaminopropylhexahydrotriazine, potassium, potassium acetate, N,N,N-trimethyl isopropyl amine/formate, and combinations thereof.

Yet further examples of other suitable catalysts, specifically tertiary amine catalysts, include dimethylaminoethanol, dimethylaminoethoxyethanol, triethylamine, N,N,N′,N′-tetramethylethylenediamine, triethylenediamine (also known as 1,4-diazabicyclo[2.2.2]octane), N,N-dimethylaminopropylamine, N,N,N′,N′,N″-pentamethyldipropylenetriamine, tris(dimethylaminopropyl)amine, N,N-dimethylpiperazine, tetramethylimino-bis(propylamine), dimethylbenzylamine, trimethylamine, triethanolamine, N,N-diethyl ethanolamine, N-methylpyrrolidone, N-methylmorpholine, N-ethylmorpholine, bis(2-dimethylamino-ethyl)ether, N,N-dimethylcyclohexylamine (“DMCHA”), N,N,N′,N′,N″-pentamethyldiethylenetriamine, 1,2-dimethylimidazole, 3-(dimethylamino) propylimidazole, 2,4,6-tris(dimethylaminomethyl) phenol, and combinations thereof. The (D) catalyst can comprise delayed action tertiary amine based on 1,8-diazabicyclo[5.4.0]undec-7-ene (“DBU”). Alternatively or in addition, the (D) catalyst can comprise N,N,N′-trimethyl-N′-hydroxyethyl-bisaminoethylether and/or ethylenediamine. The tertiary amine catalysts can be further modified for use as delayed action catalysts by addition of approximately the same stoichiometric amount of acidic proton containing acid, such as phenols or formic acid. Such delayed action catalysts are commercially available from Air Products and Evonik.

The (D) catalyst may be utilized neat or disposed in a carrier vehicle. Carrier vehicles are known in the art and further described below as an optional component for the composition. If the carrier vehicle is utilized and solubilizes the (D) catalyst, the carrier vehicle may be referred to as a solvent. The carrier vehicle can be isocyanate-reactive, e.g. an alcohol-functional carrier vehicle, such as dipropylene glycol.

The (D) catalyst can be utilized in various amounts. One of skill in the art readily understands how to determine a suitable or catalytic amount of the (D) catalyst.

In these or other embodiments, the isocyanate-functional prepolymer and/or isocyanate-functional polymer is prepared in the presence of (E) a filler. Typically, the filler is selected from a reinforcing filler, an extending filler, a rheological modifying filler, a mineral filler, a glass filler, a carbon filler, or a combination thereof. However, the isocyanate-functional prepolymer and/or isocyanate-functional polymer may be combined with the (E) filler after its preparation.

The (E) filler may be untreated, pretreated, or added in conjunction with an optional filler treating agent, described below, which when so added may treat the (E) filler in situ and/or prior to use. The (E) filler may be a single filler or a combination of two or more fillers that differ in at least one property such as type of filler, method of preparation, treatment or surface chemistry, filler composition, filler shape, filler surface area, average particle size, and/or particle size distribution.

The shape and dimensions of the (E) filler is also not specifically restricted. For example, the (E) filler may be spherical, rectangular, ovoid, irregular, and may be in the form of, for example, a powder, a flour, a fiber, a flake, a chip, a shaving, a strand, a scrim, a wafer, a wool, a straw, a particle, and combinations thereof. Dimensions and shape are typically selected based on the type of the (E) filler utilized, and an end use application of the isocyanate-functional prepolymer (and isocyanate component including the same). In certain embodiments, the (E) filler has an average particle size or average largest dimension of from greater than 0 to 500, alternatively from greater than 0 to 450, alternatively from greater than 0 to 400, alternatively from greater than 0 to 350, alternatively from greater than 0 to 300, alternatively from greater than 0 to 250, alternatively from greater than 0 to 200, alternatively from greater than 0 to 150, alternatively from greater than 0 to 100, microns. In other embodiments, the (E) filler has an average particle size or average largest dimension of from greater than 0 to 500, alternatively from greater than 0 to 450, alternatively from greater than 0 to 400, alternatively from greater than 0 to 350, alternatively from greater than 0 to 300, alternatively from greater than 0 to 250, alternatively from greater than 0 to 200, alternatively from greater than 0 to 150, alternatively from greater than 0 to 100, nanometers. Methods of measuring average particle size are known in the art, e.g. via light scattering techniques, such as dynamic light scattering.

Non-limiting examples of fillers that may function as reinforcing fillers include reinforcing silica fillers such as fume silica, silica aerogel, silica xerogel, and precipitated silica. Fumed silicas are known in the art and commercially available; e.g., fumed silica sold under the name CAB-O-SIL by Cabot Corporation of Massachusetts, U.S.A.

Non-limiting examples fillers that may function as extending or reinforcing fillers include quartz and/or crushed quartz, aluminum oxide, magnesium oxide, silica (e.g. fumed, ground, precipitated), hydrated magnesium silicate, magnesium carbonate, dolomite, silicone resin, wollastonite, soapstone, kaolinite, kaolin, mica muscovite, phlogopite, halloysite (hydrated alumina silicate), aluminum silicate, sodium aluminosilicate, glass (fiber, beads or particles, including recycled glass, e.g. from wind turbines or other sources), clay, magnetite, hematite, calcium carbonate such as precipitated, fumed, and/or ground calcium carbonate, calcium sulfate, barium sulfate, calcium metasilicate, zinc oxide, talc, diatomaceous earth, iron oxide, clays, mica, chalk, titanium dioxide (titania), zirconia, sand, carbon black, graphite, anthracite, coal, lignite, charcoal, activated carbon, non-functional silicone resin, alumina, silver, metal powders, magnesium oxide, magnesium hydroxide, magnesium oxysulfate fiber, aluminum trihydrate, aluminum oxyhydrate, coated fillers, carbon fibers (including recycled carbon fibers, e.g. from the aircraft and/or automotive industries), poly-aramids such as chopped KEVLAR™ or Twaron™, nylon fibers, mineral fillers or pigments (e.g. titanium dioxide, non-hydrated, partially hydrated, or hydrated fluorides, chlorides, bromides, iodides, chromates, carbonates, hydroxides, phosphates, hydrogen phosphates, nitrates, oxides, and sulfates of sodium, potassium, magnesium, calcium, and barium; zinc oxide, antimony pentoxide, antimony trioxide, beryllium oxide, chromium oxide, lithopone, boric acid or a borate salt such as zinc borate, barium metaborate or aluminum borate, mixed metal oxides such as vermiculite, bentonite, pumice, perlite, fly ash, clay, and silica gel; rice hull ash, ceramic and, zeolites, metals such as aluminum flakes or powder, bronze powder, copper, gold, molybdenum, nickel, silver powder or flakes, stainless steel powder, tungsten, barium titanate, silica-carbon black composite, functionalized carbon nanotubes, cement, slate flour, pyrophyllite, sepiolite, zinc stannate, zinc sulphide), and combinations thereof. Alternatively, the extending or reinforcing filler may be selected from the group consisting of calcium carbonate, talc and a combination thereof.

Extending fillers are known in the art and commercially available; such as a ground silica sold under the name MIN-U-SIL by U.S. Silica of Berkeley Springs, WV. Suitable precipitated calcium carbonates include Winnofil™ SPM from Solvay and Ultra-pflex™ and Ultra-pflex™ 100 from SMI.

Alternatively, the (E) filler can be selected from the group consisting of aluminum nitride, aluminum oxide, aluminum trihydrate, aluminum oxyhydrate, barium titanate, barium sulfate, beryllium oxide, carbon fibers, diamond, graphite, magnesium hydroxide, magnesium oxide, magnesium oxysulfate fiber, metal particulate, onyx, silicon carbide, tungsten carbide, zinc oxide, coated fillers, and a combination thereof.

Metallic fillers include particles of metals, metal powders, and particles of metals having layers on the surfaces of the particles. These layers may be, for example, metal nitride layers or metal oxide layers. Suitable metallic fillers are exemplified by particles of metals selected from the group consisting of aluminum, copper, gold, nickel, silver, and combinations thereof, and alternatively aluminum. Suitable metallic fillers are further exemplified by particles of the metals listed above having layers on their surfaces selected from the group consisting of aluminum nitride, aluminum oxide, copper oxide, nickel oxide, silver oxide, and combinations thereof. For example, the metallic filler may comprise aluminum particles having aluminum oxide layers on their surfaces. Inorganic fillers are exemplified by onyx; aluminum trihydrate, aluminum oxyhydrate, metal oxides such as aluminum oxide, beryllium oxide, magnesium oxide, and zinc oxide; nitrides such as aluminum nitride; carbides such as silicon carbide and tungsten carbide; and combinations thereof. Alternatively, inorganic fillers are exemplified by aluminum oxide, zinc oxide, and combinations thereof.

Alternatively, the (E) filler may comprise a non-reactive silicone resin. For example, the (E) filler may comprise a non-reactive MQ silicone resin. As known in the art, M siloxy units are represented by R⁰₃SiO_{1/2}, and Q siloxy units are represented by SiO_{4/2}, where R⁰ is an independently selected substituent. Such non-reactive silicone resins are typically soluble in liquid hydrocarbons such as benzene, toluene, xylene, heptane and the like or in liquid organosilicon compounds such as a low viscosity cyclic and linear polydiorganosiloxanes. The molar ratio of M to Q siloxy units in the non-reactive silicone resin may be from 0.5/1 to 1.5/1, alternatively from 0.6/1 to 0.9/1. These mole ratios can be conveniently measured by Silicon 29 Nuclear Magnetic Resonance Spectroscopy (²⁹Si NMR), which is described in U.S. Pat. No. 9,593,209 Reference Example 2 in col. 32, which is incorporated by reference herein. The non-reactive silicone resin may further comprise 2.0 wt. % or less, alternatively 0.7 wt. % or less, alternatively 0.3 wt. % or less, of T units including a silicon-bonded hydroxyl or a hydrolyzable group, exemplified by alkoxy such as methoxy and ethoxy, and acetoxy, while still being within the scope of such non-reactive silicone resins. The concentration of hydrolyzable groups present in the non-reactive silicone resin can be determined using Fourier Transform-Infrared (FT-IR) spectroscopy.

Alternatively or in addition, the (E) filler may comprise a non-reactive silicone resin other than the non-reactive MQ silicone resin described immediately above. For example, the (E) filler may comprise a T resin, a TD resin, a TDM resin, a TDMQ resin, or any other non-reactive silicone resin. Typically, such non-reactive silicone resins include at least 30 mole percent T siloxy and/or Q siloxy units. As known in the art, D siloxy units are represented by R⁰₂SiO_{2/2}, and T siloxy units are represented by R⁰SiO_{3/2}, where R⁰ is an independently selected substituent.

The weight average molecular weight, M_{w}, of the non-reactive silicone resin will depend at least in part on the molecular weight of the silicone resin and the type(s) of substituents (e.g. hydrocarbyl groups) that are present in the non-reactive silicone resin. M_{w} as used herein represents the weight average molecular weight measured using conventional gel permeation chromatography (GPC), with narrow molecular weight distribution polystyrene (PS) standard calibration, when the peak representing the neopentamer is excluded from the measurement. The PS equivalent M_{w} of the non-reactive silicone resin may be from 12,000 to 30,000 g/mole, typically from 17,000 to 22,000 g/mole. The non-reactive silicone resin can be prepared by any suitable method. Silicone resins of this type have been prepared by cohydrolysis of the corresponding silanes or by silica hydrosol capping methods generally known in the art.

Regardless of the selection of the (E) filler, the (E) filler may be untreated, pretreated, or added to form the composition in conjunction with an optional filler treating agent, which when so added may treat the (E) filler in situ in the composition.

The filler treating agent may comprise a silane such as an alkoxysilane, an alkoxy-functional oligosiloxane, a cyclic polyorganosiloxane, a hydroxyl-functional oligosiloxane such as a dimethyl siloxane or methyl phenyl siloxane, an organosilicon compound, a stearate, or a fatty acid. The filler treating agent may comprise a single filler treating agent, or a combination of two or more filler treating agents selected from similar or different types of molecules.

The filler treating agent may comprise an alkoxysilane, which may be a mono-alkoxysilane, a di-alkoxysilane, a tri-alkoxysilane, or a tetra-alkoxysilane. Alkoxysilane filler treating agents are exemplified by hexyltrimethoxysilane, octyltriethoxysilane, decyltrimethoxysilane, dodecyltrimethoxysilane, tetradecyltrimethoxysilane, phenyltrimethoxysilane, phenylethyltrimethoxysilane, octadecyltrimethoxysilane, octadecyltriethoxysilane, and a combination thereof. In certain aspects the alkoxysilane(s) may be used in combination with silazanes, which catalyze the less reactive alkoxysilane reaction with surface hydroxyls. Such reactions are typically performed above 100° C. with high shear with the removal of volatile by-products such as ammonia, methanol and water.

Suitable filler treating agents also include alkoxysilyl functional alkylmethyl polysiloxanes, or similar materials where the hydrolyzable group may comprise, for example, silazane, acyloxy or oximo.

Alkoxy-functional oligosiloxanes can also be used as filler treating agents. Alkoxy-functional oligosiloxanes and methods for their preparation are generally known in the art. Other filler treating agents include mono-endcapped alkoxy functional polydiorganosiloxanes, i.e., polyorganosiloxanes having alkoxy functionality at one end.

Alternatively, the filler treating agent can be any of the organosilicon compounds typically used to treat silica fillers. Examples of organosilicon compounds include organochlorosilanes such as methyltrichlorosilane, dimethyldichlorosilane, and trimethyl monochlorosilane; organosiloxanes such as hydroxy-endblocked dimethylsiloxane oligomer, silicon hydride functional siloxanes, hexamethyldisiloxane, and tetramethyldivinyldisiloxane; organosilazanes, such as hexamethyldisilazane and hexamethylcyclotrisilazane; and organoalkoxysilanes such as alkylalkoxysilanes with methyl, propyl, n-butyl, i-butyl, n-hexyl, n-octyl, i-octyl, n-decyl, dodecyl, tetradecyl, hexadecyl, or octadecyl substituents. Organoreactive alkoxysilanes can include amino, methacryloxy, vinyl, glycidoxy, epoxycyclohexyl, isocyanurato, isocyanato, mercapto, sulfido, vinyl-benzyl-amino, benzyl-amino, or phenyl-amino substituents. Alternatively, the filler treating agent may comprise an organopolysiloxane. The use of such a filler treating agent to treat the surface of the (E) filler may take advantage of multiple hydrogen bonds, either clustered or dispersed or both, as the method to bond the organosiloxane to the surface of the (E) filler. The organosiloxane capable of hydrogen bonding has an average, per molecule, of at least one silicon-bonded group capable of hydrogen bonding. The group may be selected from a monovalent organic group having multiple hydroxyl functionalities or a monovalent organic group having at least one amino functional group. Hydrogen bonding may be a primary mode of bonding of the filler treating agent to the (E) filler. The filler treating agent may be incapable of forming covalent bonds with the (E) filler. The filler treating agent capable of hydrogen bonding may be selected from the group consisting of a saccharide-siloxane polymer, an amino-functional organosiloxane, and a combination thereof. Alternatively, the filler treating agent capable of hydrogen bonding may be a saccharide-siloxane polymer.

Alternatively, the filler treating agent may comprise alkylthiols such as octadecyl mercaptan and others, and fatty acids such as oleic acid, stearic acid, titanates, titanate coupling agents, zirconate coupling agents, and a combination thereof. One skilled in the art could optimize a filler treating agent to aid dispersion of the (E) filler without undue experimentation.

If utilized, the relative amount of the filler treatment agent and the (E) filler is selected based on the particular filler utilized as well as the filler treatment agent, and desired effect or properties thereof.

The amount of the (E) filler utilized, if at all, is a function of many variables. For example, the (E) filler can be incorporated into an isocyanate component comprising the isocyanate-functional prepolymer and/or isocyanate-functional polymer, or a composition including the isocyanate component. As such, the (E) filler is optional when preparing the isocyanate-functional prepolymer and/or isocyanate-functional polymer, and if present, can be utilized in any amount up to the total loading desired in the ultimate isocyanate component or composition, as described below.

An isocyanate component comprising the isocyanate-functional prepolymer is also disclosed. Any of the components described below for the isocyanate component can be utilized when preparing the isocyanate-functional prepolymer, i.e., the isocyanate-functional prepolymer can be formed in situ to give the isocyanate component. Alternatively, the isocyanate-functional prepolymer may be prepared and subsequently combined with the other components of the isocyanate component. In certain embodiments, the isocyanate component is substantially free from isocyanate-functional components or compounds other than the isocyanate-functional prepolymer. By “substantially free,” in reference to the isocyanate component being substantially free from isocyanate-functional components or compounds other than the isocyanate-functional prepolymer, it is meant that the isocyanate component comprises the isocyanate-functional prepolymer, along with any residual unreacted molecules of the (C) polyisocyanate utilized to prepare the isocyanate-functional prepolymer. Said differently, in such embodiments, a conventional polyisocyanate is typically not discretely included in the isocyanate component separate from the (C) polyisocyanate utilized to prepare the isocyanate-functional prepolymer. In certain embodiments, the isocyanate component comprises isocyanate-functional components or compounds other than the isocyanate-functional prepolymer in an amount of from 0 to 10, alternatively from 0 to 9, alternatively from 0 to 8, alternatively from 0 to 7, alternatively from 0 to 6, alternatively from 0 to 5, alternatively from 0 to 4, alternatively from 0 to 3, alternatively from 0 to 2, alternatively from 0 to 1, alternatively 0, weight percent based on the total weight of isocyanate-functional components or compounds in the isocyanate component, including the isocyanate-functional prepolymer.

The isocyanate component further comprises the (E) filler, as described above. In certain embodiments, the isocyanate component comprises the (E) filler in an amount of from greater than 0 to 10, alternatively from greater than 0 to 9, alternatively from greater than 0 to 8, alternatively from greater than 0 to 7, alternatively from greater than 0 to 6, alternatively from 1 to 6, alternatively from 1 to 5, alternatively from 1 to 4, alternatively from 1 to 3, alternatively from 2 to 6, weight percent based on the total weight of the isocyanate component.

The isocyanate component, including the isocyanate-functional prepolymer and/or isocyanate-functional polymer and the (E) filler, typically exhibits a reduced viscosity at higher shear rates and increased viscosity at low shear rates, i.e., the isocyanate component is shear thinning. This allows for more efficient use, particularly in forming coatings, than conventional coatings utilizing Newtonian or lower shear thinning components. Moreover, the isocyanate component can help prevent impregnation of the isocyanate component on a porous substrate, e.g. fabric, when preparing a coating.

In certain embodiments, the isocyanate component further comprises a pH modifier or stabilizer. Specific examples thereof include diethylmalonate, alkylphenol alkylates, paratoluene sulfonic isocyanates, benzoyl chloride and orthoalkyl formates. When utilized, the pH modifier or stabilizer is typically present in the isocyanate component in an amount of from greater than 0 to 5, alternatively from greater than 0 to 4, alternatively from greater than 0 to 3, alternatively from greater than 0 to 2, alternatively from greater than 0 to 1, alternatively from greater than 0 to 0.8, alternatively from greater than 0 to 0.5, weight percent based on the total weight of the isocyanate component.

In various embodiments, the isocyanate component has a content of NCO by weight of from 1 to 20, alternatively from 2 to 17.5, alternatively from 3 to 15, alternatively from 4 to 12.5, wt. %. Methods of determining content of NCO by weight are known in the art based on functionality and molecular weight of the particular isocyanate.

A composition is also disclosed. The composition comprises the isocyanate component described above and an isocyanate-reactive component. The composition may be referred to as a polyurethane composition, as the composition cures to give a polyurethane. The composition is typically free from blowing agents, aside from any gasses formed as byproducts from reacting the isocyanate component and the isocyanate-reactive component, such that the polyurethane formed therefrom is an elastomer rather than a foam.

The isocyanate-reactive component comprises a polyol. The polyol of the isocyanate-reactive component may be the same as or different from the (A) polyol utilized to prepare the isocyanate-functional prepolymer of the isocyanate component. In certain embodiments, the polyol of the isocyanate-reactive component is different form the (A) polyol utilized to prepare the isocyanate-functional prepolymer of the isocyanate component.

Specific examples of polyols are described above with respect to the (A) polyol utilized to prepare the isocyanate-functional prepolymer of the isocyanate component. In certain embodiments, the polyol of the isocyanate-reactive component comprises a polyether polyol such as polyoxypropylene triols and poly(oxyethylene-oxypropylene)triols obtained by the simultaneous or sequential addition of ethylene and propylene oxides to trifunctional initiators. Polyether polyols having higher functionalities than triols can also be utilize in lieu of or in addition to polyether diols and/or triols.

In various embodiments, the polyol has a hydroxyl (OH) number of from greater than 10 to 100, alternatively from 20 to 90, alternatively from 30 to 80, alternatively from 40 to 70, alternatively from 50 to 60, mg KOG/g. Hydroxyl number can be measured via various techniques, such as in accordance with ASTM D4274. In these or other embodiments, the polyol has a number average molecular weight of from 2,000 to 4,000, alternatively from 2,250 to 3,750, alternatively from 2,500 to 3,500, alternatively from 2,750 to 3,250, alternatively from 2,900 to 3,100, Daltons. As readily understood in the art, number average molecular weight can be measured via gel permeation chromatography (GPC).

In these or other embodiments, the polyol has a functionality of from 2 to 10, alternatively from 2 to 9, alternatively from 2 to 8, alternatively from 2 to 7, alternatively from 2 to 6, alternatively from 2 to 4, alternatively from 2.5 to 3.5.

In specific embodiments, the polyol of the isocyanate-reactive component has a higher functionality and molecular weight than the (A) polyol utilized to prepare the isocyanate-functional prepolymer.

The isocyanate-reactive component may further comprise a chain extender. As readily understood in the art, chain extenders typically include two or more, but typically two, isocyanate-reactive groups (or active hydrogen atoms). These isocyanate-reactive groups are preferably in the form of hydroxyl, primary amino, secondary amino, or mixtures of two or more of these groups. The term “active hydrogen atoms” refers to hydrogen atoms that, because of their placement in a molecule, display activity according to the Zerewitinoff test as described by Kohler in J. Am. Chemical Soc., 49, 31-81 (1927). When the chain extender is a diol, the resulting product is a thermoplastic polyurethane (TPU). When the chain extender is a diamine or an amino alcohol, the resulting product is a thermoplastic polyurea (TPUU).

The chain extenders may be aliphatic, cycloaliphatic, or aromatic, and are exemplified by diols, diamines, and amino alcohols. Illustrative of the difunctional chain extenders are ethylene glycol, diethylene glycol, propylene glycol, dipropylene glycol, 1,3-propanediol, 1,3-butanediol, 1,4-butanediol, 1,5-pentanediol and other pentane diols, 2-ethyl-1,3-hexanediol, 2-ethyl-1,6-hexanediol, other 2-ethyl-hexanediols, 1,6-hexanediol and other hexanediols, 2,2,4-trimethylpentane-1,3-diol, decanediols, dodecanediols, bisphenol A, hydrogenated bisphenol A, 1,4-cyclohexanediol, 1,4-bis(2-hydroxyethoxy)-cyclohexane, 1,3-cyclohexanedimethanol, 1,4-cyclohexanediol, 1,4-bis(2-hydroxyethoxy)benzene, Esterdiol 204 (propanoic acid, 3-hydroxy-2,2-dimethylpropyl ester available from TCI America), N-methylethanolamine, N-methyl iso-propylamine, 4-aminocyclohexanol, 1,2-diaminotheane, 1,3-diaminopropane, diethylenetriamine, toluene-2,4-diamine, and toluene-1,6-diamine. Aliphatic compounds containing from 2 to 8 carbon atoms are most typical. Amine chain extenders include, but are not limited to, ethylenediamine, monomethanolamine, and propylenediamine.

Commonly used linear chain extenders are generally diol, diamine or amino alcohol compounds characterized by having a molecular weight of not more than 400 g/mol (or Dalton). In this context, by “linear,” it is meant that no branching from tertiary carbon is included. Examples of suitable chain extenders are represented by the following formulae: HO—(CH₂)ₙ—OH, H₂N—(CH₂)ₙ—NH₂, and H₂N—(CH₂)ₙ—OH, where subscript n is typically a number from 1 to 50.

One common chain extender is 1,4-butane diol (“butane diol” or “BDO”), and is represented by the following formula: HO—CH₂CH₂CH₂CH₂—OH. Other suitable chain extenders include ethylene glycol; diethylene glycol; 1,3-propanediol; 1,6-hexanediol; 1,5-heptanediol; triethyleneglycol; and combinations of two or more of these extenders.

Also suitable are cyclic chain extenders, which are generally diol, diamine or amino alcohol compounds, characterized by having a molecular weight of not more than 400 g/mol. In this context, by “cyclic” it is meant a ring structure, and typical ring structures include, but are not limited to, the 5 to 8 member ring structures with hydroxylalkyl branches.

When utilized, the isocyanate-reactive component typically comprises the chain extender in an amount of from greater than 0 to 40, alternatively from greater than 0 to 35, alternatively from 5 to 30, alternatively from 10 to 30, alternatively from 15 to 30, weight percent based on the total weight of the isocyanate-reactive component.

The isocyanate-reactive component may further comprise an additional amount of the (D) catalyst and/or (E) filler described above with regard to the isocyanate component. Typically, both the isocyanate component and the isocyanate-reactive component include the (E) filler. For example, the isocyanate-reactive component can comprise the (E) filler in an amount of from greater than 0 to 20, alternatively from greater than 0 to 15, alternatively from greater than 0 to 10, alternatively from 2 to 9, alternatively from 2 to 8, alternatively from 2 to 7, alternatively from 2 to 6, weight percent based on the total weight of the isocyanate-reactive component. The (E) filler present in the isocyanate-reactive component, if any, can be the same as or different form the (E) filler utilized in the isocyanate component. Suitable examples are described above.

In specific embodiments, the isocyanate-reactive component consists essentially of the polyol, and optionally any chain extender, filler, and catalyst. By “consists essentially of” in this context, it is meant that the isocyanate-reactive component is free of components other than the polyol and the chain extender which would react with an isocyanate to give carbamate (urethane) or carbodiimide bonds. Thus, the isocyanate-reactive component can comprise other components or additives, such as any of the further components or optional additives described below, even when the isocyanate-reactive component consists essentially of the polyol and optionally any chain extender, filler, and catalyst, so long as such other components or additives are non-reactive.

The composition may optionally further include an additive component. The additive component may be selected from the group of catalysts, plasticizers, cross-linking agents, chain-terminating agents, wetting agents, surface modifiers, surfactants, waxes, moisture scavengers, desiccants, viscosity reducers, reinforcing agents, dyes, pigments, colorants, flame retardants, mold release agents, anti-oxidants, compatibility agents, ultraviolet light stabilizers, thixotropic agents, anti-aging agents, lubricants, coupling agents, rheology promoters, thickeners, fire retardants, smoke suppressants, anti-static agents, anti-microbial agents, and combinations thereof.

One or more of the additives can be present as any suitable weight percent (wt. %) of the composition, such as 0.1 wt. % to 15 wt. %, 0.5 wt. % to 5 wt. %, or 0.1 wt. % or less, 1 wt. %, 2, 3, 4, 5, 6, 7, 8, 9, 10, 11, 12, 13, 14, or 15 wt. % or more of the composition. One of skill in the art can readily determine a suitable amount of additive depending, for example, on the type of additive and the desired outcome. Certain optional additives are described in greater detail below.

Suitable pigments are understood in the art. In various embodiments, the composition further comprises carbon black, e.g. acetylene black.

Typically, the composition is a 2k (two-component) composition. In these or other embodiments, the composition is not a dispersion, and is a 100% solids system (i.e., comprising 100 wt. % solids).

The composition may be prepared by combining the isocyanate-reactive component and the isocyanate component in any order of addition, optionally under shear. The composition can be prepared in situ in an end use application, i.e., the isocyanate-reactive component and the isocyanate component may be combined during an end use application of the composition, or may be formed and subsequently utilized. The composition can be formed at room temperature and ambient conditions. Alternatively, at least one condition may be selectively modified during formation of the composition, e.g. temperature, humidity, pressure, etc.

A coating and a coated substrate formed with the composition are also disclosed. The coating and the coated substrate are formed by disposing the composition on a substrate and forming the coating from the composition on the substrate. Typically, forming the coating from the composition on the substrate comprises curing the composition to give the coating. The coating is generally a polyurethane elastomer. Curing conditions can be readily identified by one of skill in the art, and typically involve exposing the composition to heat to form the coating, e.g. a temperature of from 100 to 200° C.

The composition may be disposed or dispensed on the substrate in any suitable manner. The composition may be applied by i) spin coating; ii) brush coating; iii) drop coating; iv) spray coating; v) dip coating; vi) roll coating; vii) flow coating; viii) slot coating; ix) gravure coating; x) Meyer bar coating; xi) screen printing; xii) knife blade coating; or xiii) a combination of any two or more of i) to xii). In specific embodiments, the composition is applied to the substrate in an amount of from 10 to 120, alternatively from 10 to 110, alternatively from 12 to 100, alternatively from 14 to 90, alternatively from 16 to 80, alternatively from 18 to 70, alternatively from 20 to 60, g/m². Because the composition is typically 100% solids, lesser amounts of the composition can be utilized to give the same coating given the lack of water or vehicle to be driven from the composition when preparing the coating. However, the amount of the composition applied on the substrate, and dimensions of the coating formed therefrom, can be selected based on end use applications thereof.

The substrate is not limited and may be any substrate. The coating may be separable from the substrate, e.g. if the substrate is a mold, or may be physically and/or chemically bonded to the substrate depending on its selection. The substrate may optionally have a continuous or non-continuous shape, size, dimension, surface roughness, and other characteristics.

The substrate may comprise a plastic, which maybe a thermoset and/or thermoplastic. However, the substrate may alternatively be or comprise glass, ceramic, metals such as titanium, magnesium, aluminum, carbon steel, stainless steel, nickel coated steel or alloys of such metal or metals, or a combination of different materials. Alternatively still, the substrate can be a fibrous material (including paper or lignocellulosics), a fabric (woven or non-woven), or a textile.

Specific examples of suitable substrates include polymeric substrates such as polyamides (PA); polyesters such as polyethylene terephthalates (PET), polybutylene terephthalates (PBT), polytrimethylene terephthalates (PTT), polyethylene naphthalates (PEN), and liquid crystalline polyesters; polyolefins such as polyethylenes (PE), ethylene/acidic monomer copolymers such as is available from Dow under the tradename Surlyn, polypropylenes (PP), and polybutylenes; polystyrene (PS) and other styrenic resins such as SB rubber; polyoxymethylenes (POM); polycarbonates (PC); polymethylmethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones; polyvinyl alcohols (PVA); polyetheretherketones (PEEK); polyetherketoneketones (PEKK); polyarylates (PAR); polyethernitriles (PEN); phenolic resins; phenoxy resins; celluloses such as triacetylcellulose, diacetylcellulose, and cellophane; fluorinated resins, such as polytetrafluoroethylenes; thermoplastic elastomers, such as polystyrene types, polyolefin types, polyurethane types, polyester types, polyamide types, polybutadiene types, polyisoprene types, and fluoro types; and copolymers, and combinations thereof. Thermosetting resins can include epoxy, polyurethane, polyurea, phenol-formaldehyde, urea-formaldehyde, or combinations thereof. The substrate can include a coating, film, or layer disposed thereon. Coatings made from polymer latex can be used, such as latex from acrylic acid, acrylates, methacrylates, methacrylic acid, other alkylacrylates, other alkylacrylic acid, styrene, isoprene butylene monomers, or latex from the alkyl esters of the acid monomers mentioned in the foregoing, or latex from copolymers of the foregoing monomers. Composites based on any of these resins can be used as substrates by combining with glass fibers, carbon fibers, or solid fillers such as calcium carbonate, clay, aluminum hydroxide, aluminum oxide, silicon dioxide, glass spheres, sawdust, wood fiber, or combination thereof.

The compositions are particularly suitable to prepare coatings for synthetic textiles, such as polyester and Nylon woven fabrics typically used in the manufacture of automotive air bags. Alternatively, the compositions may be used to prepare protective coatings, coatings to reduce permeability of the substrate to gases including air, or for any other purpose for which coatings are used. Generally, the composition prepares coatings that are capable of imparting tear strength, abrasion resistance, hydrophobicity, and/or impact resistance, to a variety of substrates.

In specific embodiments, the substrate is an air bag. The inventive composition is generally less expensive than conventional silicone coatings, and does not require devolatization when the composition comprises 100% by weight solids. Further, the isocyanate-functional prepolymer is typically shear thinning, particularly when utilized in combination with the (E) filler, which results in reduced viscosity at high shear rates, increasing efficiency with coating preparation. In addition, in view of inclusion of the (E) filler, the composition typically does not impregnate the substrate, which reduces stiffness of the coated substrate and better retains gasses (e.g. when utilized on an air bag which is deployed).

Embodiment 1 relates to an isocyanate-functional prepolymer comprising the reaction product of: (A) a polyol; (B) an organopolysiloxane having at least two carbinol-functional groups per molecule; and (C) a polyisocyanate; wherein components (A) to (C) are utilized to provide a stoichiometric excess of isocyanate-functional groups in component (C) over the total amount of isocyanate-reactive groups of components (A) and (B).

Embodiment 2 relates to isocyanate-functional prepolymer of Embodiment 1, wherein: (i) the carbinol-functional groups are the same as one another; (ii) the carbinol-functional groups have the general formula -D-Oₐ—(C_{b}H_{2b}O)_{c}—H, where D is a covalent bond or a divalent hydrocarbon linking group having from 2 to 18 carbon atoms, subscript a is 0 or 1, subscript b is independently selected from 2 to 4 in each moiety indicated by subscript c, and subscript c is from 0 to 500, with the proviso that subscripts a and c are not simultaneously 0; or (iii) both (i) and (ii).

Embodiment 3 relates to the isocyanate-functional prepolymer of Embodiment 1 or 2, wherein: (i) at least one of the carbinol-functional groups has the general formula -D-OH, where D is a covalent bond or a divalent hydrocarbon linking group having from 2 to 18 carbon atoms; (ii) the carbinol-functional groups are terminal; or (iii) both (i) and (ii).

Embodiment 4 relates to the isocyanate-functional prepolymer of Embodiment 1 or 2, wherein: (i) at least one of the carbinol-functional groups has the general formula:

-D-Oₐ—[C₂H₄O]ₓ[C₃H₆O]_{y}[C₄H₈O]_{z}—H;

where D is a covalent bond or a divalent hydrocarbon linking group having from 2 to 18 carbon atoms, subscript a is 0 or 1, 0≤x≤500, 0≤y≤500, and 0≤z≤500, with the proviso that 1≤(x+y+z)≤500; (ii) the carbinol-functional groups are pendent; or (iii) both (i) and (ii).

Embodiment 5 relates to the isocyanate-functional prepolymer of any one of Embodiments 1-4, having: (i) an NCO content by weight of from 2.5 to 12.5%; (ii) a backbone comprising at least one siloxane moiety formed from component (B), the siloxane moiety being present in the backbone in an amount of from 0.1 to 10 wt. % based on the total weight of the backbone; or (iii) both (i) and (ii).

Embodiment 6 relates to the isocyanate-functional prepolymer of any one of Embodiments 1-5, wherein: (i) component (B) has a viscosity at 25° C. of from 1 to 1,000 mPa·s; (ii) component (B) is substantially linear; (iii) component (B) has the general formula:

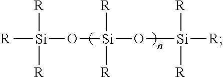

where each R is an independently selected hydrocarbyl group or comprises a carbinol-functional group, with the proviso that at least two of R independently comprise a carbinol-functional group, and subscript n is from 0 to 100; (iv); component (C) comprises polymeric MDI (pMDI); (v) the isocyanate-functional prepolymer is formed in the presence of (D) a catalyst and (E) a filler; or (vi) any combination of (i) to (v).

Embodiment 7 relates to an isocyanate component comprising: the isocyanate-functional prepolymer of any one of Embodiments 1-6; and (E) a filler.

Embodiment 8 relates to a composition comprising: the isocyanate component of Embodiment 7; and an isocyanate-reactive component.

Embodiment 9 relates to the composition of Embodiment 8, wherein: (i) the composition is a two component (2k) system; (ii) the composition comprises 100 wt. % solids; or (iii) both (i) and (ii).

Embodiment 10 relates to the composition of Embodiment 8 or 9, wherein the isocyanate-reactive component comprises (A) a polyol, and wherein the (A) polyol: (i) has a number-average functionality of from 2 to 8; (ii) has an average OH equivalent weight of from greater than 0 to 2,000; (iii) is a polyether polyol; or (iv) any combination of (i) to (iii).

Embodiment 11 relates to the composition of one of Embodiments 8-10, wherein: (i) the isocyanate-reactive component comprises (F) a chain extender: (ii) the isocyanate-reactive component comprises (E) a filler; or (iii) both (i) and (ii).

Embodiment 12 relates to a method of preparing a coating, the method comprising: applying the composition of one of Embodiments 8-11 on a substrate; and forming the coating from the composition on the substrate.

Embodiment 13 relates to a method of preparing a coating, the method comprising:
applying a polyurethane composition on a substrate; and
forming the coating from the polyurethane composition on the substrate;
wherein the polyurethane composition comprises:
   an isocyanate component, comprising:
      an isocyanate-functional polymer comprising the reaction product of a polyol and an isocyanate, and
   an isocyanate-reactive component comprising a polyol.

Embodiment 14 relates to a coated substrate comprising: a substrate; and a coating disposed on the substrate; wherein the coating is formed from the composition of one of Embodiments 8-11 or according to the method of Embodiment 13.

Embodiment 15 relates to the coated substrate of Embodiment 14, wherein: (i) the substrate comprises a fabric; (ii) the substrate is woven or non-woven; (iii) the substrate comprises an airbag; or (iv) any combination of (i) to (iii).

The following examples, illustrating embodiments of this disclosure, are intended to illustrate and not to limit the invention. Unless otherwise noted, all reactions are carried out under air, and all components are purchased or otherwise obtained from various commercial suppliers.

The following equipment and characterization procedures/parameters are used to evaluate various physical properties of the compounds and compositions prepared in the examples below.

Capillary viscosity (kinematic viscosity via glass capillary) was measured via Dow Corning Corporate Test Method CTM0004 method of 20 Jul. 1970, for silicone containing materials (Component (B)). CTM0004 is known in the art and based on ASTM D445, IP 71.

The various components utilized in the Examples are set forth in Table 1 below.

TABLE 1
Components/Compounds Utilized

| Component | Description |
|---|---|
| Component | A homopolymer diol having a number average molecular |
| (A1) | weight of 2,000 Da, a hydroxyl number of 55.2 mg KOG/g |
| | (as measured in accordance with ASTM D4274), and a |
| | viscosity of 373 mPa · s at 25° C. (as measured in |
| | accordance with ASTM D4878). |
| Component | A glycerin-initiated homopolymer triol, having a number |
| (A2) | average molecular weight of 3,000 Da, a hydroxyl number |
| | of 56.0 mg KOG/g (as measured in accordance with ASTM |
| | D4274), and a viscosity of 484 cSt at 77° C. (as measured |
| | in accordance with ASTM D445). |
| Component | A polypropylene glycol, propylene glycol initiated, |
| (A3) | homopolymer diol having a number average molecular |
| | weight of 400 Da, a hydroxyl number of 250-270 mg KOG/ |
| | g (as measured in accordance with ASTM D4274), and a |
| | viscosity of 65 mPa · s at 25° C. (as measured in |
| | accordance with ASTM D445). |
| Component | A bis-hydroxyethoxypropyl dimethicone having a capillary |
| (B) | viscosity at 25° C. of 50 cSt and an OH equivalent weight |
| | of 569 g/mol. |
| Component | A polymeric MDI having a nominal functionality of 2.3 and |
| (C) | an NCO content by weight of 32% (as measured in |
| | accordance with ASTM D5155). |
| Component | A mixture of 97 wt. % stannous octoate in 2-ethylhexanoic |
| (D) | acid. |
| Component | A fumed silica filler surface treated with polydimethyl- |
| (E1) | siloxane having a specific surface area (BET) of from |
| | 80-120 m²/g. |
| Component | An untreated fumed silica having a submicron particle size |
| (E2) | and hydrophilic properties. |
| Chain | Butane diol |
| Extender | |
| pH Modifier | Benzoyl chloride |

### Preparation Examples 1-9

In Preparation Examples 1-9, isocyanate components comprising isocyanate-functional prepolymers were generally synthesized in a dried container in a glove box based on the components and the amounts as set forth below in Table 2. In particular, in each of Preparation Examples 1-9, Component (A1), Component (B) (with the exception of Preparation Example 9, which does not utilize Component (B)), and Component (D) were disposed in a SpeedMixer cup and mixed via a FlackTek DAC 600 FVZ SpeedMixer and mixed at 2000 rpm for 60 seconds. Then, Component (C) was disposed in the SpeedMixer cup and the contents were once again mixed with the FlackTek DAC 600 FVZ SpeedMixer and mixed at 2000 rpm for 30 seconds. The contents were then transferred to a dry glass container and allowed to react in an oven at 80° C. for 4 hr to complete the prepolymer reaction. Upon cooling, the contents were divided into aliquots and the desired mass of component (E1) or (E2) was incorporated in multiple stages of approximately 1% filler by weight for each iterative addition until the total amount of Component (E1) or (E2) is incorporated. Mixing was accomplished with a FlackTek DAC 150 speedmixer with a mixing speed of 2000 rpm for 15 seconds for each approximately 1% filler increment. In between mixing, a wooden tongue depressor was utilized to scrape down the sides of the container to ensure full incorporation of the filler. To degas the samples, a final multi-step mixing protocol was performed under reduced pressure using a FlackTek 600.2 VAC LR speedmixer with a mixing speed of 800 rpm for 30 seconds followed immediately by 2000 rpm for 30 seconds.

TABLE 2
Preparation Examples 1-9

| | Preparation Example: | | | | | | | | |
|---|---|---|---|---|---|---|---|---|---|
| Component: | 1 | 2 | 3 | 4 | 5 | 6 | 7 | 8 | 9 |
| (C) (g) | 40.69 | 40.69 | 40.69 | 40.99 | 41.30 | 31.21 | 30.66 | 24.65 | 32.45 |
| (A1) (g) | 57.90 | 57.91 | 57.91 | 52.14 | 44.93 | 67.17 | 67.93 | 73.82 | 47.28 |
| (A2) (g) | — | — | — | — | — | — | — | — | 20.26 |
| (B) (g) | 1.36 | 1.36 | 1.36 | 6.82 | 13.72 | 1.57 | 1.36 | 1.48 | — |
| (D) (g) | 0.05 | 0.05 | 0.05 | 0.05 | 0.05 | 0.05 | 0.05 | 0.05 | — |
| (E1) (g) | — | 2.00 | 4.00 | 4.00 | 4.00 | 4.00 | 6.00 | 6.00 | — |
| (E2) (g) | 2.00 | — | — | — | — | — | — | — | — |
| pH Modifier (g) | 0.06 | 0.06 | 0.06 | 0.31 | 0.63 | 0.07 | 0.06 | 0.07 | — |

### Comparative Preparation Examples 1-4

In Comparative Preparation Examples 1-4, isocyanate components comprising isocyanate-functional prepolymers were generally synthesized in a dried container in a glove box based on the components and the amounts as set forth below in Table 3. In particular, in each of Comparative Preparation Examples 1-4, Component (A1) (and Component (A2), if utilized), and Component (D), if utilized, were disposed in a SpeedMixer cup and mixed via a FlackTek DAC 600 FVZ SpeedMixer and mixed at 2000 rpm for 60 seconds. Then, Component (C) was disposed in the SpeedMixer cup and the contents were once again mixed with the FlackTek DAC 600 FVZ SpeedMixer and mixed at 2000 rpm for 30 seconds. The contents were then transferred to a dry glass container and allowed to react in an oven at 80° C. for 4 hr to complete the prepolymer reaction. Upon cooling, the contents were divided into aliquots and the desired mass of component (E1) or (E2) was incorporated in multiple stages of approximately 1% filler by weight for each iterative addition until the total amount of Component (E1) or (E2) is incorporated. Mixing was accomplished with a FlackTek DAC 150 speedmixer with a mixing speed of 2000 rpm for 15 seconds for each approximately 1% filler increment. In between mixing, a wooden tongue depressor was utilized to scrape down the sides of the container to ensure full incorporation of the filler. To degas the samples, a final multi-step mixing protocol was performed under reduced pressure using a FlackTek 600.2 VAC LR speedmixer with a mixing speed of 800 rpm for 30 seconds followed immediately by 2000 rpm for 30 seconds.

TABLE 3
Comparative Preparation Examples 1-4

Comparative Preparation Example:

| Component: | 1 | 2 | 3 | 4 |
|---|---|---|---|---|
| (C) (g) | 39.13 | 40.68 | 40.68 | 40.68 |
| (A1) (g) | 60.87 | 59.27 | 59.27 | 59.27 |
| (A2) (g) | — | — | — | — |
| (B) (g) | — | — | — | — |
| (D) (g) | — | 0.05 | 0.05 | 0.05 |
| (E1) (g) | — | — | 2.00 | 4.00 |
| (E2) (g) | — | 2.00 | — | — |
| pH Modifier (g) | — | — | — | — |

### Control Example, Examples 1-9, and Comparative Examples 1-4

Compositions are prepared with the isocyanate components and isocyanate-functional prepolymers made in Preparation Examples 1-9, the isocyanate-component and isocyanate-functional polymer made in Preparation Example 9, and the isocyanate components made in Comparative Preparation Examples 1-4. In addition, the Control Example below utilizes a conventional polymeric MDI rather than an isocyanate-functional prepolymer. Examples 1-9 utilize the isocyanate components and isocyanate-functional prepolymers made above in Preparation Examples 1-9, respectively, and Comparative Examples 1˜4 utilize the isocyanate components and isocyanate-functional prepolymers made above in Comparative Preparation Examples 1-4, respectively. Table 4 below shows the components utilized in Examples 1-9. The isocyanate-reactive component includes the components in Table 4 that are not part of the particular isocyanate component.

TABLE 4

| | Example: | | | | | | | | |
|---|---|---|---|---|---|---|---|---|---|
| Component: | 1 | 2 | 3 | 4 | 5 | 6 | 7 | 8 | 9 |
| Isocyanate Component | 102.06 | — | — | — | — | — | — | — | — |
| 1 (g) | | | | | | | | | |
| Isocyanate Component | — | 102.07 | — | — | — | — | — | — | — |
| 2 (g) | | | | | | | | | |
| Isocyanate Component | — | — | 104.07 | — | — | — | — | — | — |
| 3 (g) | | | | | | | | | |
| Isocyanate Component | — | — | — | 104.31 | — | — | — | — | — |
| 4 (g) | | | | | | | | | |
| Isocyanate Component | — | — | — | — | 104.63 | — | — | — | — |
| 5 (g) | | | | | | | | | |
| Isocyanate Component | — | — | — | — | — | 104.07 | — | — | — |
| 6 (g) | | | | | | | | | |
| Isocyanate Component | — | — | — | — | — | — | 106.06 | — | — |
| 7 (g) | | | | | | | | | |
| Isocyanate Component | — | — | — | — | — | — | — | 106.07 | — |
| 8 (g) | | | | | | | | | |
| Isocyanate Component | — | — | — | — | — | — | — | — | 99.99 |
| 9 (g) | | | | | | | | | |
| % NCO Isocyanate | 10.5 | 10.5 | 10.5 | 10.5 | 10.6 | 7.1 | 6.9 | 4.7 | 9.4 |
| Component | | | | | | | | | |
| (A1) (g) | — | — | — | — | — | — | — | — | — |
| (A2) (g) | 71.50 | 71.53 | 71.53 | 72.16 | 72.80 | 51.52 | 83.24 | 67.09 | — |
| Chain Extender (g) | 28.50 | 28.47 | 28.47 | 27.84 | 27.20 | — | 16.76 | — | 99.90 |
| (A3) (g) | — | — | — | — | — | 48.48 | — | 32.91 | — |
| (D) (g) | — | — | — | — | — | — | — | — | 0.10 |
| Filler (per 100 parts | 8.50 | 4.50 | 4.50 | 4.50 | 4.50 | 4.50 | 4.50 | 4.50 | — |
| (A1)-(A3) and Chain | | | | | | | | | |
| Extender) | | | | | | | | | |
| Isocyanate | 2.82 | 2.82 | 2.82 | 2.75 | 2.69 | 1.75 | 2.75 | 2.07 | 12.42 |
| Component:Isocyanate- | | | | | | | | | |
| reactive component | | | | | | | | | |
| weight ratio | | | | | | | | | |

Table 5 below shows the components utilized in the Control Example and Comparative Examples 1-4. In Table 5, “Cont.” indicates Control Example, and C.E. designates Comparative Example.

TABLE 5

| | Example: | | | | |
|---|---|---|---|---|---|
| Component: | Cont. | C.E.1 | C.E. 2 | C.E.3 | C.E.4 |
| Component | 100 | | | | |
| (C) | | | | | |
| Comparative | — | — | — | — | — |
| Isocyanate | | | | | |
| Component | | | | | |
| 1 (g) | | | | | |
| Comparative | — | 100.00 | — | — | — |
| Isocyanate | | | | | |
| Component | | | | | |
| 2 (g) | | | | | |
| Comparative | — | — | 102.00 | — | — |
| Isocyanate | | | | | |
| Component | | | | | |
| 3 (g) | | | | | |
| Comparative | — | — | — | 102.00 | — |
| Isocyanate | | | | | |
| Component | | | | | |
| 4 (g) | | | | | |
| Comparative | — | — | — | — | 104.00 |
| Isocyanate | | | | | |
| Component | | | | | |
| 5 (g) | | | | | |
| % NCO | 32 | 12.1 | 10.5 | 10.5 | 10.5 |
| Isocyanate | | | | | |
| Component | | | | | |
| (A1) (g) | 62.52 | — | — | — | — |
| (A2) (g) | 26.8 | — | 71.5 | 71.5 | 71.5 |
| Chain | 10.68 | 99.9 | 28.5 | 28.5 | 28.5 |
| Extender (g) | | | | | |
| (A3) (g) | — | — | — | — | — |
| (D) (g) | 0.14 | 0.1 | — | — | — |
| Filler (per | — | — | 8.5 | 4.5 | 4.5 |
| 100 parts | | | | | |
| (A1)-(A3) | | | | | |
| and Chain | | | | | |
| Extender) | | | | | |
| Isocyanate | 0.43 | 9.36 | 2.83 | 2.81 | 2.81 |
| Component:Iso- | | | | | |
| cyanate- | | | | | |
| reactive | | | | | |
| component | | | | | |
| weight ratio: | | | | | |

Coatings were prepared with the compositions of Examples 1-9, the Control Example, and Comparative Examples 1-4. In particular, 40 grams of each composition were disposed in a 100 mL sample container and mixed for 20 seconds at 2000 rpm using a DAC 150 mixer. The container was opened and the side was scraped and kneaded to the center of the container. The container was placed back into the mixer and mixed for an additional 20 seconds at 2000 rpm.

A piece of 12″×17″ fabric (scoured 470 DTEX PET) was mounted onto a Mathis Lab Coater LTE-S coating frame and stretched tight. The fabric was pre-dried for 2 minutes at 150° C. to drive off any residual moisture. A coating knife was mounted into a raised coating head and approximately 10 g of each coating was deposited with a spatula in front of the blade. The coating knife was then pulled towards the operator to draw a film onto the fabric at a rate of about 2 inches per second. Coating thickness was adjusted by setting the gap between the blade and the support roll. The coated fabric was then transferred into the oven and cured for 3 minutes at 150° C. to give a cured coating. After curing, the fabric including the cured coating was removed from the oven.

Tables 6 and 7 below show the performance properties associated with the cured coatings formed with the compositions of Examples 1-9, the Control Example, and Comparative Examples 1-4. Rheological measurements (viscosity) were performed using an AR-G2 from TA Instruments using 25 mm parallel plates with a 500 μm gap and a conditioning step of 1 min at 25° C. prior to data collection. King stiffness is measured in accordance with ASTM D4032. The viscosity values in Tables 6 and 7 relating to filled prepolymers are the viscosities of the Isocyanate Components formed in Preparation Examples 1-9 (or Control or Comparative Examples 1-4) prior to reaction with the isocyanate-reactive components.

TABLE 6

| | Example: | | | | | | | | |
|---|---|---|---|---|---|---|---|---|---|
| Property: | 1 | 2 | 3 | 4 | 5 | 6 | 7 | 8 | 9 |
| Filled Prepolymer | 20.22 | 98 | 538.4 | 390.7 | 190.9 | 551.7 | 1524 | 1920 | — |
| Viscosity at | | | | | | | | | |
| 0.09999 1/s (Pa · s) | | | | | | | | | |
| Filled Prepolymer | 12.33 | 17.19 | 36.05 | 24.28 | 17.25 | 54.97 | 91.06 | 243.3 | — |
| Viscosity at | | | | | | | | | |
| 10 1/s (Pa · s) | | | | | | | | | |
| Rheology Slope | −0.14 | −0.40 | −0.60 | −0.62 | −0.54 | −0.51 | −0.62 | −0.46 | — |
| [log(Pa · s)/ | | | | | | | | | |
| log(s⁻¹)] | | | | | | | | | |
| Coating | 26 | 35 | 35 | ~35 | ~35 | ~35 | ~35 | ~35 | 35 |
| Thickness (gsm) | | | | | | | | | |
| King | 35 | 43 | 31 | 47* | 49* | 30* | 28* | 23* | 27 |
| Stiffness (N) | | | | | | | | | |

*the King Stiffness values indicate measurements completed after 6 or 7 days rather than ~2 hrs after coating. There is no data available to what extent the King Stiffness changes several days after coating.

TABLE 7

| | Example: | | | | |
|---|---|---|---|---|---|
| Property: | Cont. | C.E.1 | C.E. 2 | C.E.3 | C.E.4 |
| Filled | — | — | 105 | 110.2 | 578.9 |
| Prepolymer | | | | | |
| Viscosity at | | | | | |
| 0.09999 1/s | | | | | |
| (Pa · s) | | | | | |
| Filled | — | — | 102.6 | 56.91 | 85.26 |
| Prepolymer | | | | | |
| Viscosity at | | | | | |
| 10 1/s (Pa · s) | | | | | |
| Rheology Slope | — | — | 0.00 | −0.20 | −0.44 |
| [log(Pa · s)/log(s⁻¹)] | | | | | |
| Coating | 45 | 26 | 35 | 41 | 40 |
| Thickness | | | | | |
| (gsm) | | | | | |
| King Stiffness | 61 | 65 | 34 | 32 | 37 |
| (N) | | | | | |

It is to be understood that the appended claims are not limited to express and particular compounds, compositions, or methods described in the detailed description, which may vary between particular embodiments which fall within the scope of the appended claims.

1. An isocyanate-functional prepolymer comprising the reaction product of:
(A) a polyol;
(B) an organopolysiloxane having at least two carbinol-functional groups per molecule; and
(C) a polyisocyanate;
wherein components (A) to (C) are utilized to provide a stoichiometric excess of isocyanate-functional groups in component (C) over the total amount of isocyanate-reactive groups of components (A) and (B).

2. The isocyanate-functional prepolymer of claim 1, wherein: (i) the carbinol-functional groups are the same as one another; (ii) the carbinol-functional groups have the general formula -D-Oₐ—(C_{b}H_{2b}O)_{c}—H, where D is a covalent bond or a divalent hydrocarbon linking group having from 2 to 18 carbon atoms, subscript a is 0 or 1, subscript b is independently selected from 2 to 4 in each moiety indicated by subscript c, and subscript c is from 0 to 500, with the proviso that subscripts a and c are not simultaneously 0; or (iii) both (i) and (ii).

3. The isocyanate-functional prepolymer of claim 1, wherein: (i) at least one of the carbinol-functional groups has the general formula -D-OH, where D is a covalent bond or a divalent hydrocarbon linking group having from 2 to 18 carbon atoms; (ii) the carbinol-functional groups are terminal; or (iii) both (i) and (ii).

4. The isocyanate-functional prepolymer of claim 1, wherein: (i) at least one of the carbinol-functional groups has the general formula:
-D-Oₐ—[C₂H₄O]ₓ[C₃H₆O]_{y}[C₄H₈O]_{z}—H;
where D is a covalent bond or a divalent hydrocarbon linking group having from 2 to 18 carbon atoms, subscript a is 0 or 1, 0≤x≤500, 0≤y≤500, and 0≤z≤500, with the proviso that 1≤(x+y+z)≤500; (ii) the carbinol-functional groups are pendent; or (iii) both (i) and (ii).

5. The isocyanate-functional prepolymer of claim 1, having: (i) an NCO content by weight of from 2.5 to 12.5%; (ii) a backbone comprising at least one siloxane moiety formed from component (B), the siloxane moiety being present in the backbone in an amount of from 0.1 to 10 wt. % based on the total weight of the backbone; or (iii) both (i) and (ii).

6. The isocyanate-functional prepolymer of claim 1, wherein: (i) component (B) has a viscosity at 25° C. of from 1 to 1,000 mPa s; (ii) component (B) is substantially linear; (iii) component (B) has the general formula: 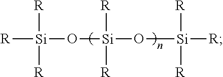
where each R is an independently selected hydrocarbyl group or comprises a carbinol-functional group, with the proviso that at least two of R independently comprise a carbinol-functional group, and subscript n is from 0 to 100; (iv); component (C) comprises polymeric MDI (pMDI); (v) the isocyanate-functional prepolymer is formed in the presence of (D) a catalyst and (E) a filler; or (vi) any combination of (i) to (v).

7. An isocyanate component comprising:
the isocyanate-functional prepolymer of claim 1; and
(E) a filler.

8. A composition comprising:
the isocyanate component of claim 7; and
an isocyanate-reactive component.

9. The composition of claim 8, wherein: (i) the composition is a two component (2k) system; (ii) the composition comprises 100 wt. % solids; or (iii) both (i) and (ii).

10. The composition of claim 8, wherein the isocyanate-reactive component comprises (A) a polyol, and wherein the (A) polyol: (i) has a number-average functionality of from 2 to 8; (ii) has an average OH equivalent weight of from greater than 0 to 2,000; (iii) is a polyether polyol; or (iv) any combination of (i) to (iii).

11. The composition of claim 8, wherein: (i) the isocyanate-reactive component comprises (F) a chain extender: (ii) the isocyanate-reactive component comprises (E) a filler; or
(iii) both (i) and (ii).

12. A method of preparing a coating, said method comprising:
applying the composition of claim 8 on a substrate; and
forming the coating from the composition on the substrate.

13. A method of preparing a coating, said method comprising:
applying a polyurethane composition on a substrate; and
forming the coating from the polyurethane composition on the substrate;
wherein the polyurethane composition comprises:
an isocyanate component, comprising:
an isocyanate-functional polymer comprising the reaction product of a polyol and an isocyanate, and
an isocyanate-reactive component comprising a polyol.

14. A coated substrate comprising:
a substrate; and
a coating disposed on the substrate;
wherein the coating is formed from the composition of claim 8.

15. The coated substrate of claim 14, wherein: (i) the substrate comprises a fabric; (ii) the substrate is woven or non-woven; (iii) the substrate comprises an airbag; or (iv) any combination of (i) to (iii).
